(19) United States
(12) Patent Application Publication
(10) Pub. No.: US 2026/0084596 A1
(43) Pub. Date: Mar. 26, 2026

(54) METHOD FOR PRODUCING A CUSHIONING ELEMENT FROM AT LEAST ONE NONWOVEN FABRIC ELEMENT AND WITH A CUSHIONING HEATING ELEMENT, VEHICLE SEAT WITH SUCH A CUSHIONING ELEMENT AND VEHICLE WITH SUCH A VEHICLE SEAT

(71) Applicant: AUDI AG, lngolstadt (DE)

(72) Inventors: Lars ELLERMANN, Weinsberg (DE); Steffen ROSS, Wettstetten (DE)

(73) Assignee: AUDI AG, lngolstadt (DE)

(21) Appl. No.: 19/305,375

(22) Filed: Aug. 20, 2025

(30) Foreign Application Priority Data
Sep. 20, 2024 (DE) 102024127186.8

(51) Int. Cl. B60N 2/56

(52) U.S. Cl. CPC B60N 2/5678

(57) ABSTRACT

A method for producing a cushioning element of a vehicle seat, by providing at least one plate-like nonwoven fabric element; inserting the nonwoven fabric element into a forming tool; arranging an electrical cushioning heating element with at least one electrical plug in the forming tool, the electrical plug and at least one portion of an electrical cable connected to the electrical plug is received in a separate cavity formed in the forming tool; closing the forming tool, the cushioning heating element is arranged on the nonwoven fabric element; swelling and forming the nonwoven fabric element under the influence of increased pressure and elevated temperature, the cushioning heating element is connected to the nonwoven fabric element; opening the forming tool and removing the formed cushioning element with the cushioning heating element connected.

### FIELD

The invention relates to a method for producing a cushioning element of a vehicle seat, a vehicle seat with at least one such cushioning element and a motor vehicle with at least one such vehicle seat.

### BACKGROUND

For sustainability reasons, there are currently efforts to produce cushioning elements from fiber materials in order to avoid foamed plastics. In the case of cushioning elements made of foamed plastic materials, a cushioning heating element, which can also be referred to as a seat heater, is attached as a separate element in a separate processing step to the finished, formed foamed cushioning element and glued to it.

For prior art, reference is made, for example, to DE 10 2010 005 994 A1 and DE 698 13 691 T2.

### SUMMARY

The object of the invention is to provide a method for producing a cushioning element from at least one nonwoven fabric element with a cushioning heating element, in which subsequent attachment of the cushioning heating element can be avoided.

A method for producing a cushioning element of a vehicle seat is therefore proposed, comprising the steps:
providing at least one plate-like nonwoven fabric element; inserting the at least one nonwoven fabric element into a forming tool; arranging an electric cushioning heating element with at least one electric plug in the forming tool, wherein the electric plug and at least a portion of an electric cable connected to the electric plug are received in a separate cavity formed in the forming tool; closing the forming tool, wherein the cushioning heating element is or will be arranged on the at least one nonwoven fabric element; swelling and forming the at least one nonwoven fabric element under the influence of increased pressure and elevated temperature, in particular by injecting a vapor fluid, in particular water vapor, wherein the cushioning heating element is materially bonded to the at least one nonwoven fabric element; opening the forming tool and removing the formed cushioning element with the cushioning heating element connected thereto, wherein the electric plug and the portion of the electric cable are removed from the separate cavity and are arranged to be freely movable on the cushioning element.

Since no liquid, especially foamed, plastic material is used in such a method, the electrical plug connection of the cushioning heating element can remain in the forming tool during the forming of the cushioning element by means of the separate cavity, so that the complete cushioning heating element can be connected to the cushioning element at the same time as the latter is being formed. This eliminates the need for a separate attachment or gluing of the cushioning heating element after the cushioning element has been formed.

In the method, the cushioning heating element may comprise a heating wire connected to the electrical plug and the portion of the electrical cable, wherein the heating wire is arranged on a heating wire carrier element, and wherein the heating wire carrier element is inserted into the forming tool on the at least one nonwoven fabric element.

The heating wire carrier element can, for example, be a flat nonwoven fabric on which or in which the heating wire is provided, in particular, in a loop-like or meandering manner. Alternatively, a loop-like or meandering heating wire can also be arranged on an adhesive strip, which serves as a heating wire carrier element.

In the method, the at least one nonwoven fabric element and/or the heating wire carrier element can have a coating of a temperature-activatable surface-adhesive material, such that the heating wire carrier element and the at least one nonwoven fabric element are materially connected to one another, in particular glued, in the closed forming tool.

To activate the coating of adhesive material, heat can be introduced into the forming tool, for example by increasing the temperature in the forming tool, which is required anyway for the forming process of the cushioning element.

In the method, alternatively or in addition to activating the coating of adhesive material, the electrical plug of the cushioning heating element can be electrically connected to an electrical socket arranged in the separate cavity, wherein current flows through the heating wire and is heated during the forming process. This allows a specific temperature level to be achieved locally in the region of the cushioning heating element or heating wire, which enables or supports the material-bonding connection between the heating wire carrier element and the cushioning element.

In the method, according to an alternative, the cushioning heating element can have a heating wire connected to the electrical plug and the portion of the electrical cable, wherein the heating wire is fixed to one tool half of the forming tool when the forming tool is open, in particular by means of several fixing pins. For example, the at least one nonwoven fabric element can be arranged in a lower tool half and the heating wire can be arranged in an upper tool half, so that the heating wire is arranged on the at least one nonwoven fabric element when the tool halves are closed.

When the forming tool is closed, the heating wire can be arranged directly on the at least one nonwoven fabric element and can be materially connected to it. In such a case, the method can thus be carried out without a heating wire carrier element.

In the method, the electrical plug of the cushioning heating element can be electrically connected to an electrical socket arranged in the cavity, wherein the heating wire is passed through by current during the forming process and is heated, in particular such that the heating wire has a temperature which is greater than a melting temperature of the at least one nonwoven fabric element. In other words, the heating wire that melts the nonwoven fabric element over a small space is directly materially connected to the nonwoven fabric element or integrated into it.

Also proposed is a vehicle seat having at least one cushioning element which has been produced according to the method described above, wherein the cushioning element with cushioning heating element is a seat cushion and/or a back cushion and/or a lateral cushion. Lateral cushions can be understood as, for example, a lateral leg guide in the region of the seat cushion or a lateral body guide in the region of the back cushion.

Furthermore, a motor vehicle with at least one such vehicle seat is also proposed.

### BRIEF DESCRIPTION OF THE FIGURES

Further advantages and details of the invention will become apparent from the following description of embodiments with reference to the figures. In particular:

FIG. 1 shows, using simplified sectional views, a method for producing a cushioning element of a vehicle seat;

FIG. 2 shows simplified and schematic plan views of cushioning heating elements with and without heating wire carrier element;

FIG. 3 shows, using simplified sectional views, a slightly modified method for producing a cushioning element of a vehicle seat;

FIG. 4 shows a simplified plan view of a cushioning element with cushioning heating element and schematically a vehicle seat and a motor vehicle.

### DETAILED DESCRIPTION

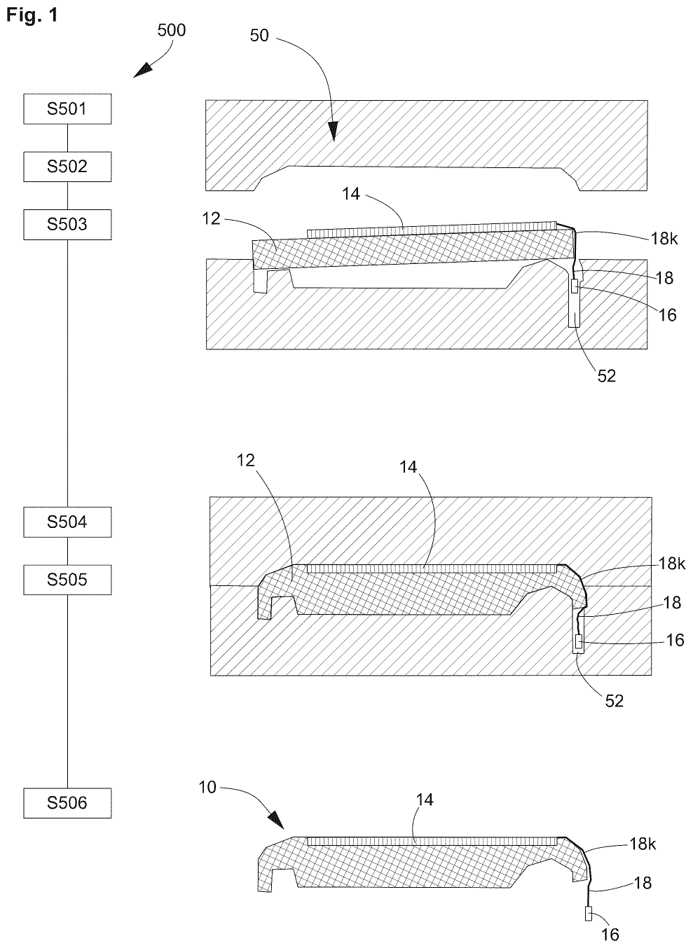

In FIG. 1, a method 500 for producing a cushioning element 10 is shown in a simplified and schematic diagram.

According to a step S501, at least one plate-like nonwoven fabric element 12 is provided, wherein the nonwoven fabric element is inserted into a forming tool 50 according to a step S502. In this context, it is pointed out that several plate-like nonwoven fabric elements 12 can also be arranged one above the other in the forming tool, from which the formed cushioning element 10 is then produced.

According to a step S503, an electrical cushioning heating element 14 with at least one electrical plug 16 is arranged in the forming tool 50, wherein the electrical plug 16 and at least a portion 18 of an electrical cable 18k connected to the electrical plug 16 is received in a separate cavity 52 formed in the forming tool 50.

According to a step S504, the forming tool 50 is closed, wherein the cushion heating element 14 is or will be arranged on the at least one nonwoven fabric element 12.

According to a step S505, the at least one nonwoven fabric element 12 is swelled and deformed under the influence of increased pressure and increased temperature, in particular by injecting a vapor fluid, in particular water vapor, wherein the cushioning heating element 14 is materially connected to the at least one nonwoven fabric element 12.

According to a step S506, the forming tool 50 is opened and the formed cushioning element 10 with the cushioning heating element 14 connected thereto is removed, wherein the electrical plug 16 and the portion 18 of the electrical cable 18k are removed from the separate cavity 52 and are arranged to be freely movable on the cushioning element 12.

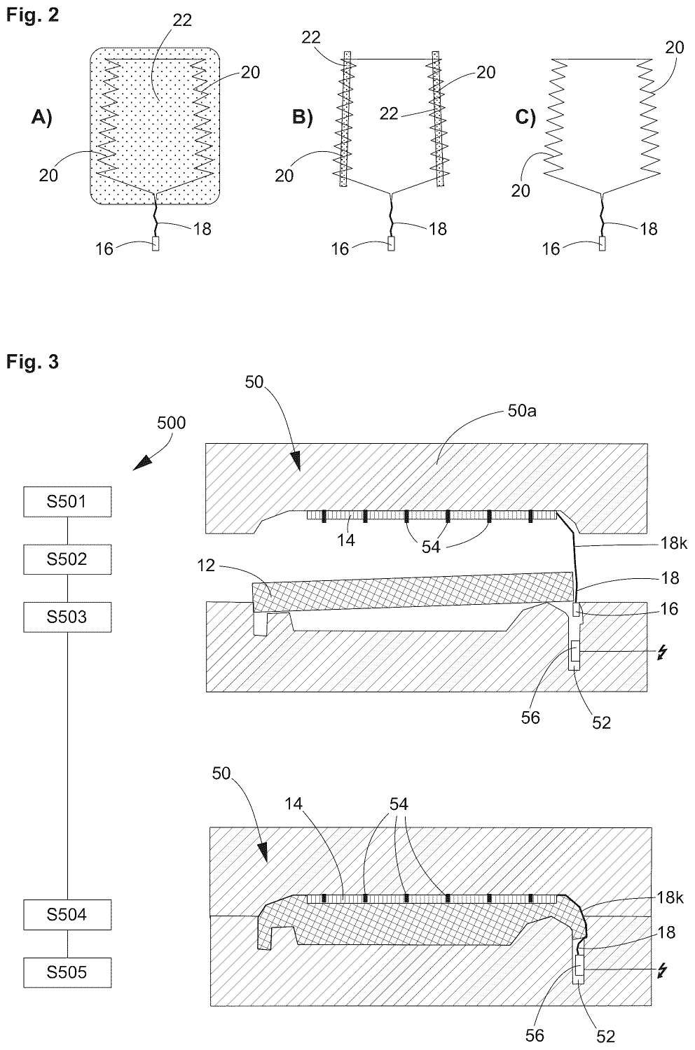

FIG. 2 shows simplified possible designs of the cushioning heating element 14. Each of the cushioning heating elements 14 has a heating wire 20 connected to the electrical plug 16 and the portion 18 of the electrical cable 18k. The heating wire is shown here in a simplified zigzag pattern. However, the heating wire 20 can also be formed in windings, loops or other courses, such as meandering.

From FIGS. 2A and 2B it can be seen that the heating wire 20 is arranged on a heating wire carrier element 22. In the example of FIG. 2A, the heating wire carrier element 22 is designed as a flat nonwoven fabric. In the example of FIG. 2B, the heating wire carrier element 22 is formed by two strips, in particular adhesive strips, on which longer portions of the heating wire 20 are arranged.

In the method 500 shown in FIG. 1, cushioning heating elements 14 with a heating wire carrier element 22 (FIGS. 2A, 2B) can be inserted into the forming tool 50 in step S503 such that the heating wire carrier element 22 rests on the at least one nonwoven fabric element 12. In other words, the cushioning heating element 14 with heating wire carrier element 22 can be arranged on a top layer of nonwoven fabric elements 12.

The at least one nonwoven fabric element 12 used in method 500 and/or the heating wire carrier element 22 (FIGS. 2A, 2B) can have a coating of a temperature-activatable surface-adhesive material, such that the heating wire carrier element 22 and the at least one nonwoven fabric element 12 are materially connected to one another, in the closed forming tool 50 in step S505. In step S505, heat is introduced into the forming tool 50 to activate the coating of adhesive material.

In FIG. 3, the method 500 of FIG. 1 is at least partially shown again, wherein here a cushioning heating element 14 according to FIG. 2C is used, which has the heating wire 20 connected to the electrical plug 16 and the portion 18 of the electrical cable 18k, but no heating wire carrier element 22. In step S503, the cushioning heating element is introduced into the forming tool, wherein in this example the heating wire 20 is fixed to a, here upper, tool half 50a of the forming tool 50 when the forming tool 50 is opened, in particular by means of multiple fixing pins 54. In this case, the heating wire 20 of the cushioning heating element 14 is arranged directly on the at least one nonwoven fabric element 12 when the forming tool 50 is closed (S504) and is materially connected to it. In other words, FIG. 3 shows a method 500 in which a cushion heating element 14 is used without a heating wire carrier element 22.

Otherwise, steps S501, S502, S504 to S507 are essentially the same as described above for FIG. 1.

In FIG. 3, an optional electrical socket 56 is shown in the separate cavity 52 of the forming tool 50. The plug 16 of the cushioning heating element 14 can be connected to this socket 56, in particular during step S503. This can be done not only in the method 500 shown in FIG. 3, but also in the method shown in FIG. 1, even if the socket 56 is not shown in FIG. 1.

Referring to the method 500 of FIG. 1 described above, to activate the coating of adhesive material, the electrical plug 16 of the cushioning heating element 14 can be electrically connected to the electrical socket 56 arranged in the separate cavity 52, wherein the heating wire 20 is heated and current flows through it during the forming process (S504, S505).

Similarly, in the method 500 described for FIG. 3, the electrical plug 16 of the cushioning heating element 14 can also be electrically connected to the electrical socket 56 arranged in the separate cavity 52, wherein the heating wire 20 of the cushioning heating element 14 is flowed through by current and heated during the forming process (S504, S505), in particular such that the heating wire (20) has a temperature which is greater than a melting temperature of the at least one nonwoven fabric element 12.

For the sake of completeness, it is also pointed out that in the method 500 described in FIG. 3, the final step S506 is also carried out, so that here too a cushioning element 10 with the properties already described above can be removed from the forming tool 50.

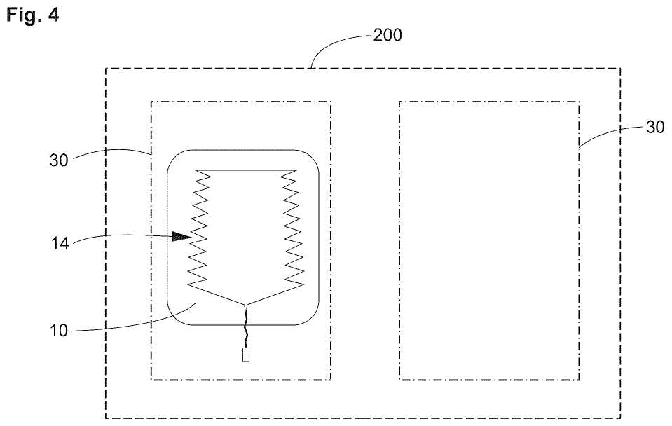

In FIG. 4, a simplified and schematic plan view of a cushioning element 10 is shown with a cushion heating element 14 materially received therein.

From FIG. 4 it is further apparent that a cushioning element 10 produced according to the method 500 described above can be part of a vehicle seat 30, which is illustrated here as a dash-dotted rectangle. Furthermore, FIG. 4 also shows that a motor vehicle 200 can have at least one such vehicle seat 30.

1. A method for producing a cushioning element of a vehicle seat, comprising:
providing at least one plate-like nonwoven fabric element;
inserting the at least one nonwoven fabric element into a forming tool;
arranging an electrical cushioning heating element with at least one electrical plug in the forming tool, wherein the electrical plug and at least a portion of an electrical cable connected to the electrical plug is received in a separate cavity formed in the forming tool;
closing, the forming tool, wherein the cushion heating element is or will be arranged on the at least one nonwoven fabric element;
swelling and forming the at least one nonwoven fabric element under the influence of increased pressure and increased temperature, in particular by injecting a vapor fluid, in particular water vapor, wherein the cushioning heating element is materially connected to the at least one nonwoven fabric element;
opening the forming tool and removing the formed cushioning element with the cushioning heating element connected thereto, wherein the electrical plug and the portion of the electrical cable are removed from the separate cavity and are arranged to be freely movable on the cushioning element.

2. The method according to claim 1, wherein the cushioning heating element has a heating wire connected to the electrical plug and the portion of the electrical cable, wherein the heating wire is arranged on a heating wire carrier element, and wherein the heating wire carrier element is inserted into the forming tool on the at least one nonwoven fabric element.

3. The method according to claim 2, wherein the at least one nonwoven fabric element and/or the heating wire carrier element have a coating of a temperature-activatable surface-adhesive material, such that the heating wire carrier element and the at least one nonwoven fabric element are materially connected to one another in the closed forming tool.

4. The method according to claim 3, wherein heat is introduced into the forming tool to activate the coating of adhesive material.

5. The method according to claim 3, wherein, in order to activate the coating of adhesive material, the electrical plug of the cushioning heating element is electrically connected to an electrical socket arranged in the separate cavity, and wherein the heating wire is passed through by current and heated during the forming process.

6. The method according to claim 1, wherein the cushioning heating element has a heating wire connected to the electrical plug and the portion of the electrical cable, wherein the heating wire is fixed to a tool half of the forming tool when the forming tool is open, in particular by means of a plurality of fixing pins.

7. The method according to claim 6, wherein the heating wire is arranged directly on the at least one nonwoven fabric element during closing of the forming tool and is materially connected thereto.

8. The method according to claim 6, wherein the electrical plug of the cushioning heating element is electrically connected to an electrical socket arranged in the separate cavity, and wherein the heating wire is passed through by current and heated during the forming, in particular such that the heating wire has a temperature which is greater than a melting temperature of the at least one nonwoven fabric element.

9. A vehicle seat with at least one cushioning element which has been produced according to the method according to claim 1, wherein the cushioning element with cushioning heating element is a seat cushion and/or a back cushion and/or a lateral cushion.

10. A motor vehicle with at least one vehicle seat according to claim 9.

11. The method according to claim 4, wherein, in order to activate the coating of adhesive material, the electrical plug of the cushioning heating element is electrically connected to an electrical socket arranged in the separate cavity, and wherein the heating wire is passed through by current and heated during the forming process.

12. The method according to claim 7, wherein the electrical plug of the cushioning heating element is electrically connected to an electrical socket arranged in the separate cavity, and wherein the heating wire is passed through by current and heated during the forming, in particular such that the heating wire has a temperature which is greater than a melting temperature of the at least one nonwoven fabric element.
